(19) United States
(12) Patent Application Publication
(10) Pub. No.: US 2004/0119755 A1
(43) Pub. Date: Jun. 24, 2004

(54) One hand quick dialer for communications devices

(76) Inventor: Nicolas Guibourge, (US)

Correspondence Address: LEE & HAYES PLLC, 421 W RIVERSIDE AVENUE SUITE 500, SPOKANE, WA, 99201

(21) Appl. No.: 10/322,816

(22) Filed: Dec. 18, 2002

(51) Int. Cl. G09G 5/00

(52) U.S. Cl. 345/827; 345/826

(57) ABSTRACT

Quick dialing methods and systems for use with communications devices are described. Such communications devices are often characterized by a limited keypad to enter contact numbers. The quick dialing technique reduces the number of keys used to dial a number, and thus a device using the technique may be operated blindly or with one hand. Exemplary methods relate the keypad and other user interfaces of the communications device with an exemplary data structure for a database of contact records. Related subject matter also facilitates quick recognition of contacts when dialing or receiving an incoming call.

### TECHNICAL FIELD

This invention relates generally to communications devices and specifically to a one hand quick dialer for communications devices.

### BACKGROUND

The information age has generated interest in faster and smaller communications devices. The availability of information has outpaced the tools used to access the information. This is evidenced by the bottleneck that computer keyboards, monitors, modems, graphic user interfaces, and other human interfaces usually present to the effortless flow of computerized information.

Communications devices are particularly prone to awkward and insufficient user interfaces for handling information. Because smaller, lighter mobile communications devices are desired, the user interfaces for such devices often become a limiting factor in miniaturization. A mobile phone, for example, typically has a limited alphanumeric keypad of approximately 12-15 keys, a significant abbreviation compared to standard computer keyboards, which have well over a hundred keys. The video display on a mobile phone is proportionately reduced.

Dialing a phone number using a mobile phone, moreover, can be difficult if the keypad is small enough. A wristwatch-size mobile phone could retain an entire phone directory in memory, but accessing the directory via the limited keypad and video display would be troublesome.

### SUMMARY

Quick dialing methods and systems for use with communications devices are described. Such communications devices are often characterized by a limited keypad to enter and access contact numbers. The described quick dialing technique reduces the number of keys used to dial a number, and thus a device using the technique may be operated blindly or with one hand.

Related methods create an exemplary database that is structured to reduce the number of keypad keys used to access contact records in the database. Creation of the database categorizes preferred and/or frequently used contacts into lists. Each list may be accessed by actuating one or two keys of a keypad. When a list is thus invoked, the contacts in the list can be invoked by actuating one or two keys. Thus, a personal contact can be dialed by actuating only a few keys.

Attributes such as colors, sounds, text fonts, graphics (i.e., pictures, icons, photos, images, animations, and bitmaps), and sorting methods are optionally assigned to lists and to the contacts within each list. When a contact is selected or dialed by actuating a key, for example, color and sound attributes associated with the list containing the contact are displayed, thereby providing visual and non-visual cues that correct keys have been actuated.

The attributes assigned to lists and to contacts within each list can also be displayed upon receiving an incoming communication. This facilitates recognition of a caller since the caller's identity can be seen and heard at a distance, for example, when the communications device audibly plays the caller's sound attribute and displays the caller's color attribute on the entire video screen or in a dedicated area of a video screen.

Each list of contacts may be sorted, and the sort method may vary between lists, e.g., a list may be sorted alphabetically, by frequency of use of the contact records in the list, by most recent use of the contact records, by assigned key number, etc. Sorting may also occur in the background to groom the lists, e.g., to remove contacts that are infrequently used or to remove a contact record of a contact that no longer exists.

### BRIEF DESCRIPTION OF THE DRAWINGS

FIG. 1 is a block diagram of an exemplary communications device including an exemplary quick dial module.

FIG. 2 is a graphic representation of an exemplary menu of lists created by the exemplary quick dial module in FIG. 1.

FIG. 3 is a block diagram of the exemplary quick dial module of FIG. 1 in greater detail.

FIG. 4 is a graphic representation of exemplary transitions between keypad interface states via assigned movement keys.

FIG. 5 is a graphic representation of exemplary relations between root and second level keypad interface states.

FIG. 6 is a flow diagram of an exemplary method of creating a database structure related to the keys of a keypad.

FIG. 7 is a flow diagram of an exemplary method of using the database structure related to the keys of a keypad created by the method shown in FIG. 7.

FIG. 8 is a graphic representation of an exemplary display of video and audio attributes that appear or are played when selecting a list.

FIG. 9 is a graphic representation of an exemplary display of video and audio attributes that appear when receiving an incoming communication.

FIG. 10 is a graphic representation of exemplary sorting methods that may be used singly or in combination in an exemplary communications device.

### DETAILED DESCRIPTION

Overview

Quick dialing methods and systems described herein organize personal contact information stored in the “phone directory” of a communications device such that a user can access names and numbers using only a few keys. The described quick dialing techniques can be used with stationary telephones, mobile phones,, portable computers, personal digital assistants, pagers, electronic inventory devices, remote control devices, and other devices that allow a user to select information using a limited number of keys, switches, or input movements, e.g., of a light pen, mouse, etc.

A communications device is any device or system that accesses a database of records to select personal contact information (“contact record”) for initiating communication with or receiving communication from a destination person or electronic device (“contact”) using a dialer. The term “contact” is used broadly in this description and can mean either the person or device communicated with or the name of the person or device as displayed or stored, i.e., a “list of contacts” means a list containing the names of contacts. The name used for a contact may be derived from pre-existing contact record information or may be user defined. Likewise, the term “list” is used broadly to mean either the list itself or the name of the list. The term “listing” is also used to denote the name of a list. Hence, a “menu of lists” means a menu containing the names (listings) of lists. A dialer is a part of a communications device that accepts user input and performs the dialing process of initiating communication. The dialer may accept user input in a number of ways, such as via a keyboard, keypad, touchpad, scroll dial, mouse, voice activity detection module, etc. Cell phones and pocket computing devices with phone capability are examples of communications devices that can access such a database of contact records using a dialer.

Exemplary Communications Device

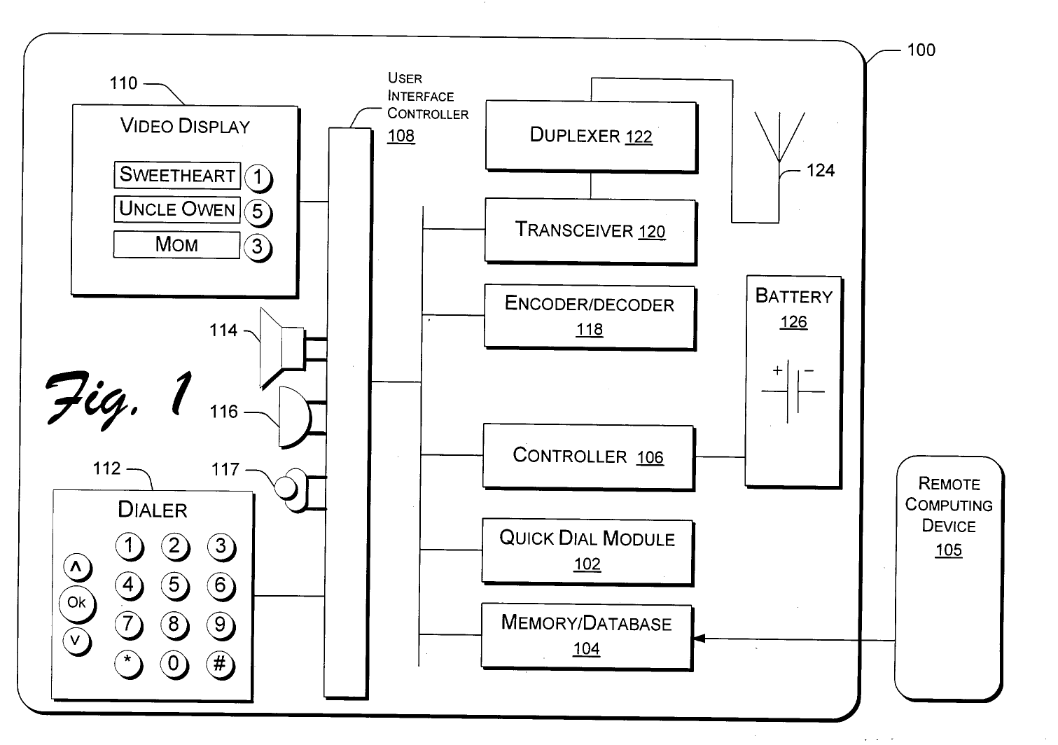

FIG. 1 shows an exemplary communications device 100 providing one environment in which exemplary subject matter can be practiced.

The communications device 100 includes an exemplary quick dial module 102, a memory/database 104 having access for uploading and downloading data from an external device, such as remote computing device 105, and a controller 1106 communicatively coupled as illustrated. The quick dial module 102 creates a data structure in the memory/database 104 and allows other components of the communications device 100 to use the data structure. A user interface controller 108 couples a video display 110, a keypad 112, a speaker 114, a microphone 116, and a camera 117 with the quick dial module 102, memory/database 104, controller 106, and various other components, such as an encoder/decoder 118, a transceiver 120, a duplexer 122 and an antenna 124. A battery 126 or other power source may be connected to modules that are implemented as discrete hardware components. If certain modules are implemented as software, however, the battery 126 or other power source may be coupled with the hardware running the software. The camera 117 of the exemplary communications device 100 can be used to produce a graphic, such as a photo or digitized bitmap etc. to be associated with a graphic attribute of lists and contact records in a quick dial data structure, as will be discussed more fully below.

A keypad is a type of dialer generally consisting of two or more keys. A key may be a hard key, such as a switch, membrane switch, capacitance switch, mouse button, etc. or may be a soft key, such as an image on a liquid crystal display (LCD) screen that a user taps with a finger or pen to input or “key in” information. The described subject matter is thus compatible with dialers, keypads, and user interfaces in general.

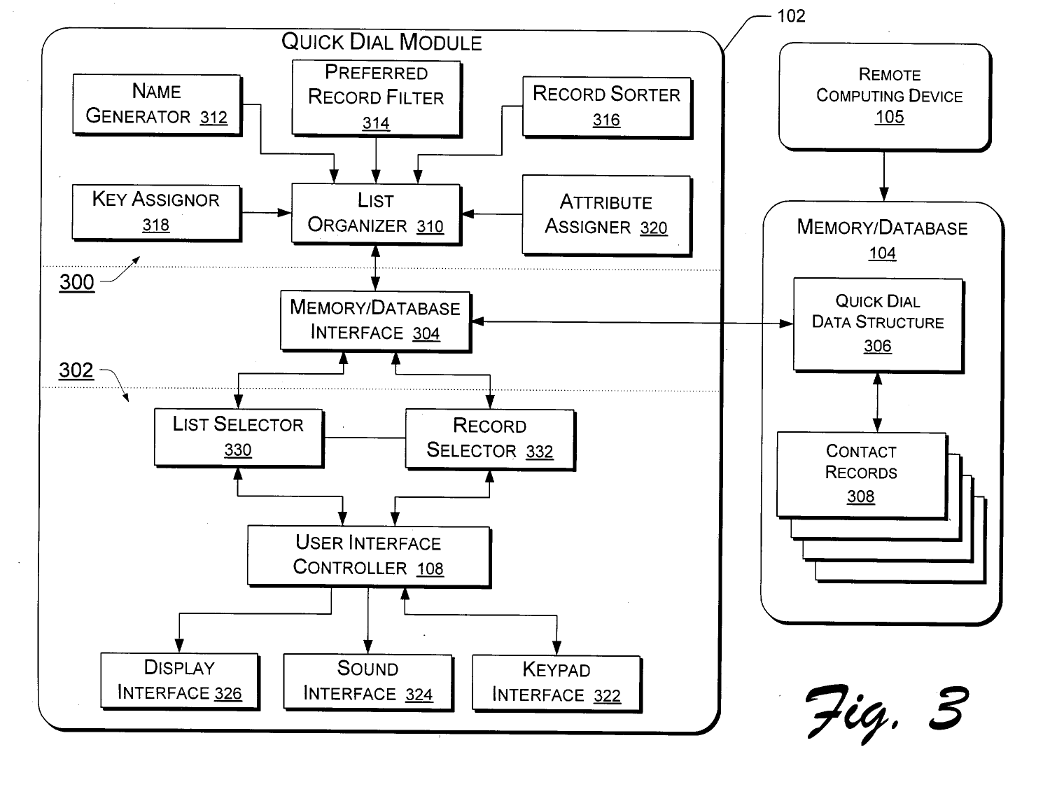

The exemplary keypad 112 includes alphanumeric keys and movement keys. Each alphanumeric key may be used to represent a number and/or one or more letters, and may be used to access a quick dial data structure 306 (FIG. 3), which will be discussed below. The movement keys may include a “Previous Key” (“▴”) and a “Next Key” (“▾”) to scroll or browse between entries (e.g., lists and contacts in lists) displayed on the video screen 110. In some implementations, one entry can be designated or highlighted as a “pre-selected” entry. A validation key, such as the “OK Key” on the exemplary keypad 112, can be used to “select” or “enter” a pre-selected entry.

Although the exemplary communications device 100 is shown as a mobile device having a battery 126 and an antenna 124 for portable use, exemplary subject matter may also be practiced with a non-portable communications device. Those having ordinary skill in the art of communications devices will appreciate that an exemplary communications device 100 suitable for practicing exemplary subject matter may have fewer, additional, and/or different modules and components that the illustrated exemplary communications device 100.

The exemplary quick dial module 102 has two aspects, performing the dual function of creating a quick dial data structure that facilitates quick dialing, and using the quick dial data structure to perform quick dialing. It should be noted that the quick dial data structure can be created on the remote computing device 105 and transferred or downloaded to the exemplary communications device 100.

Creating a Quick Dial Data Structure

An exemplary quick dial data structure as described below may be created by a communications device, such as the exemplary communications device 100, or may be created on a remote computing device 105.

In one exemplary implementation, the quick dial module 102 creates the quick dial data structure by filtering pre-existing contact records in the memory/database 104 to achieve a narrowed field of preferred contacts, such as favorite or most frequently used contacts. In addition to filtering contact records in a pre-existing database, the quick dial module 102 can derive preferred contacts from new contact records input by a user or downloaded from a remote computing device 105. After the quick dial module 102 has obtained a group of preferred contacts from contact records, whether the preferred contacts were obtained by filtering pre-existing contact records, by receiving new user input, and/or by downloading, the quick dial module 102 organizes the preferred contacts into lists, for example by theme. Alternatively, the quick dial module 102 or the remote computing device 105 can create empty lists first, and add preferred contacts by filtering, by accepting user input, and/or by downloading into the newly created user-defined and/or automatically generated empty lists.

The quick dial module 102 can employ user input not only to receive data comprising a new contact record, but also to receive preferences regarding the filtering and organizing into lists when creating a quick dial data structure. The degree to which the quick dial module 102 uses the user input depends on the particular implementation. In one implementation, the quick dial module 102 allows the user to select all the lists and arrange contacts in each list. In another implementation, parts of the filtering and/or organizing are performed automatically. For example, the user may create new lists to add to a set of automatically generated lists. In still another implementation, the quick dial module 102 performs all of the filtering and organizing automatically with little or no user input, generating a set of lists and automatically adding contacts from a pre-existing database to the lists based on criteria such as frequency of use or a characteristic built into the contact records, such as telephone area code.

As mentioned above, the filtering of database records and the organizing into lists do not need to be performed in any order. Nor do the filtering and organizing require the quick dial module 102 to delete and/or move actual contact records in the memory/database 104. The filtering and organizing can be done logically, for example, by indexing. However, actual segregation of records in subdirectories corresponding to lists, or maintaining a list profile record that stores the contacts in each list can also be used.

In some cases, the more aggressively the contact records in the memory/database 104 are filtered for creation of the quick dial data structure, the more effective the quick dialing will be, e.g., in the case of a very large database of contact records thinned down from several hundred to approximately 10-12 of the most frequently used contact records, the resulting increase in effectiveness is very great.

In an example scenario, if Nicolas is a caller whose portable handheld phone stores several hundred phone contacts, perhaps only twelve of the several hundred contacts are ever used with appreciable frequency. The quick dial module 102 filters the twelve frequently used contact records from the rest of the contact records and categorizes the twelve into lists: four are family members, three are friends, two are cafés, and three are work contacts. The quick dial module 102 assigns each of these lists to a key on the dialer, which on Nicolas's phone is the keypad 112. The lists can be displayed on a video display 110 as a menu. In one implementation, the quick dial module 102 also assigns each contact in each list to a key on the keypad 112.

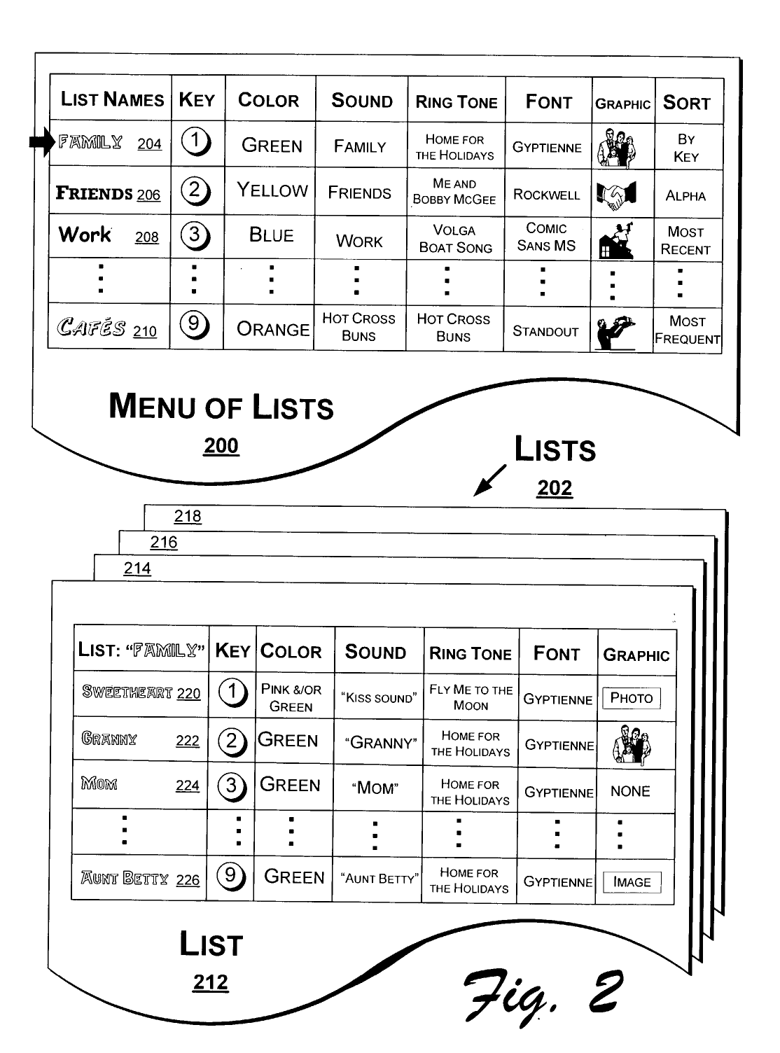

FIG. 2 shows an exemplary menu of lists 200 and the lists 202 themselves created and/or downloaded by the quick dial module 102. As discussed above, the quick dial module 102 can generate and/or download new lists 202 at any time and can add (and/or download) contacts to the lists 202 at any time.

In the illustrated menu of lists 200, the exemplary quick dial module 102 has created a set of lists 202, displayed on the menu of lists 200 as the family listing 204, the “friends” listing 206, the “work” listing 208 . . . and the “cafés” listing 210. The quick dial module 102 has assigned keys 1, 2, 3 . . . 9 to the lists, respectively. The family listing 204 corresponds to a family list 212, and the “friends” listing 206, “work” listing 208, and “cafés” listing 210 correspond respectively to a friends list 214, a work list 216, and a cafés list 218.

The family list 212 includes contacts that have been placed in the family list 212 by virtue of a common characteristic. Within the family list 212, the “Sweetheart” contact 220 has been assigned to (or associated with) the “1” key. Likewise, the “Granny” contact 222 has been assigned to the “2” key, the “Mom” contact 224 has been assigned to the “3” key, and the “Aunt Betty” contact 226 has been assigned to the “9” key. Using these assigned keys to achieve quick dialing will be discussed below under “Using the Quick Dial Data Structure.”

The quick dial data structure created by the exemplary quick dial module 102 or downloaded after being created on the remote computing device 105, may optionally include attributes assigned to each list, and may also include attributes assigned to each contact within a list. These quick dial attributes may include text fonts, text foreground colors, background colors, sounds, graphics (i.e., pictures, icons, photos, images, animations, and/or bitmaps), and sorting methods as well as key and/or dialer characteristics. In the illustrated menu of lists 200, the family listing 204 and the corresponding family list 212 are assigned the exemplary color green, the exemplary sound “family” (which in this exemplary case consists of the word “family” recorded by the exemplary user, Nicolas, and stored on the exemplary communications device 100, or synthesized by a text to speech engine, to be played when the family list 212 is selected or pre-selected by the user), the exemplary ring tone (or melody) “Home for the Holidays” to be played when a incoming call comes from a contact that belongs to this list, the exemplary text font “Gyptienne,” an exemplary picture or icon of a family, and an exemplary sorting method “by key number.”

The exemplary “friends” listing 206 and the corresponding exemplary friends list 214 are assigned exemplary attributes, such as the color yellow, the sound “friends,” the ring tone (or melody) “Me and Bobby McGee,” the text font “Rockwell,” a picture or icon of a friendly handshake, and a sorting method “alphabetical.” Attributes can likewise be assigned to additional lists. The “work” listing 208 and the corresponding work list 216 can be assigned exemplary attributes, such as the color blue, the sound “work,” the ring tone (or melody) “Volga Boat Song,” the text font “Comic Sans MS,” a picture or icon of a worker, and a sorting method “most recent.” The “cafés” listing 210 and the corresponding cafés list 218 are assigned exemplary attributes, such as the color orange, “Hot Cross Buns” for the sound and the ring tone (or melody), the text font “Standout,” an icon of a waiter, and a sorting method “most frequent.”

Thus, lists 202 may have attributes assigned to help the user distinguish the lists from each other. A contact record within a list may optionally be assigned attributes as well, in addition to the attributes of the list to which the contact record belongs. The contact record attributes may be displayed in addition to or in place of the attributes of the list to which the contact record belongs. For example, the “Sweetheart” contact 220 has been assigned a unique color attribute of pink in addition to or in place of the family list 212 color attribute of green. The sound attribute “kiss sound,” the ring tone or melody “Fly me to the Moon,” and a photo of “Sweetheart” have been assigned to the “Sweetheart” contact 220. A unique text font for the “Sweetheart” contact 220 has not been assigned, so the text font attribute remains the default text font attribute assigned to the family listing 204, that is, the Gyptienne text font attribute for the family listing 204 is used for all of the contacts in the family list 212 that have not been assigned their own text font attributes.

The assigned attributes may be used in numerous ways. The green color attribute assigned to the family listing 204 may be assigned both to the foreground text font of the family listing 204 and to the foreground text font of any contacts in the family list 212. The green color may also be assigned to at least part of the background displayed on the video display 110 when a contact in the family list 212 is validated, entered, selected, and/or dialed, or when a call is received from the contact.

The sound assigned to the family listing 204 may likewise be played whenever the family list 212 is invoked, either by actuating a key assigned to the family listing 204 or by selecting the family listing 204 using movement keys on the keypad 112, and/or whenever a contact in the family list 212 is invoked.

The ring tone or melody assigned to the family listing 204 may be played whenever an incoming call is received from a contact that belongs to the family list 212. If a contact has its own ring tone or melody, e.g., the “Sweetheart” contact 220, then the specific ring tone or melody is played instead of the one associated with the family listing 204.

The font, graphic, icon, photo, and/or other visual attributes may be displayed whenever the family listing 204 or a contact in the family list 212 appears. These visual attributes help the user to perform quick dialing by differentiating the family listing 204 from other listings and by differentiating contacts in the family list 212 from contacts in other lists as when, for example, the contacts from many lists are mixed together in a long display, e.g., in a general display (not by list) of all the contacts in the memory/database 104.

Using the Quick Dial Data Structure

Continuing the example scenario, when Nicolas selects one of the listings on the menu of lists 200 by actuating its assigned key or, by pre-selecting the list using movement keys, such as the Next and/or Previous Keys, and validating the pre-selection using an “Enter” key or an “OK” key, the quick dial module 102 activates an interface state (i.e., a “keypad interface state”) in which the keys of the keypad 112 are now enabled to invoke the contacts in the selected list.

When Nicolas actuates the “1” key from the menu of lists 200, for example, the family list 212, which corresponds to the family listing 204 on the menu of lists 200, is displayed on the video display 10. From the menu of lists 200, had the “2” key been actuated instead of the “1” key, then the friends list 214 would be enabled instead of the family list 212. But since the “1” key was actuated enabling the family list 212 to be displayed and accessed, a contact number for the “Sweetheart” contact 220 may be dialed and/or connected to by again actuating the “1” key, i.e., a first actuation of the “1” key invokes the family list 212 and a second actuation of the “1” key dials a number and/or initiates connection with Sweetheart 220. Likewise, actuating the “2” key from the family list 212 would dial Granny 222.

If Nicolas is driving along a dark highway, he can dial Sweetheart's number with one hand without looking at his phone. When the quick dial module 102 is activated, the menu of lists 200 is accessible and Nicolas can invoke the family list 212 by pressing the “1” key or by pre-selecting the family list 212 using movement keys and then selecting the pre-selection using a validation key, etc. When Nicolas is browsing the menu of lists 200 using the movement keys of the keypad 112, the quick dial module 102 can play, in one exemplary implementation, the sound associated with each list when each list is pre-selected, e.g., the sound “family” when the family listing 204 is pre-selected or the sound “friends” when the “friends” listing 206 is pre-selected. Nicolas knows accurately which list is currently pre-selected without having to remember its key number. Further, since Nicolas has called Sweetheart many times, he knows that the family list 212 is associated with the “1” key when the menu of lists 200 is accessible. He also knows that Sweetheart is also associated with the “1” key once the family list 212 has been invoked from the menu of lists 200. When the family list 212 has been selected, if Nicolas presses the “1” key, he will hear the “kiss sound” which is associated with the “Sweetheart” contact 220. Hearing this, Nicolas knows that he is calling “Sweetheart” 220 without having directly visualized the video display 110.

The quick dial data structure allows for even more flexibility. Sweetheart 220 may have multiple contact numbers, for example, a home number, a mobile number, and an office number. A contact such as Sweetheart 220 can itself be a list. Thus, Nicolas might press the “1” key for the mobile number, the “2” key for the office number, or the “3” key for the home number. In one implementation, Nicolas can always have the same keys used to represent home, office, mobile etc. when a contact has multiple contact numbers. If Nicolas cannot remember the meaning of the keys or uses a device that has no numeric keys, he can always use the “Next,” “Previous,” and a validation key (“OK Key”) from the keypad 112 to select and validate a phone number that he wants to dial. In such case, he can choose to hear the sound or name of each phone number as each phone number is pre-selected or, in some implementations, as each phone number is highlighted. Of course, if the contact Nicolas wants to call has only one phone number then the list of multiple phone numbers for the one contact is skipped and the contact is called immediately.

Thus, when Nicolas quick dials Sweetheart 220, as he actuates the “1” key from the menu of lists 200, Nicolas hears the “family” sound (or an excerpt if it is long), which he has assigned to the family listing 204. Hearing the sound verifies that he has selected the family list 212. Out of the corner of his eye, Nicolas notices the entire video screen (or an assigned portion thereof) of his mobile phone has turned a green color, the color he assigned to the family listing 204 and the family list 212. Now Nicolas again actuates the “1” key, the number he assigned to the Sweetheart contact 220. The “Kiss sound” verifies that Nicolas has just chosen Sweetheart and the video screen displays a pink color and/or the photo which is associated with the “Sweetheart” contact 220 verifying that Sweetheart 220 is the contact who is being or will be dialed. Nicolas already knows that Sweetheart is not at home, so he actuates the “1” key again to call her at her mobile number, and a sound “mobile phone” verifies that Nicolas has dialed Sweetheart's mobile phone number.

Sweetheart does not answer, however, so Nicolas leaves a message to return the call. Nicolas is also expecting a call from his boss, but had hoped to talk to Sweetheart before talking to his boss. The sound attribute assigned to Nicolas's boss is a recitation of the boss's name, Perry. That is, when Perry is dialed by Nicolas or Perry calls Nicolas, Nicolas's cell phone audibly recites the name “Perry.” In this case, Nicolas has associated the same sound for the contact attributes “sound” and “ring tone.” After a few minutes of heavy rain and careful driving, the phone rings playing the family ring tone, but not Sweetheart's ring tone, and displaying the family color, but not Sweetheart's color. Without taking his eyes off the road, Nicolas knows the call is from a family member, but not from his Sweetheart. He also knows the call is not from his boss.

The previous scenario uses sounds to identify lists and contacts, another scenario can use one or more graphics to identify lists and contacts (colors, pictures, icons, photos, images, bitmaps, etc). For example, Granddad is a young grandfather who is always traveling. Unfortunately, because of his age, he can not hear very well and needs spectacles to read. Therefore, when he wants to make a call with his mobile device, such as the exemplary communications device 100, he uses icons and pictures that are associated with the lists in the menu of lists 200 or with the contacts in the family list 212 to select the person he wants to call. In such case, he does not have to read the names of listings or contacts and therefore does not have to wear his spectacles. In addition, if Granddad does not want the people around him to hear sounds that are played when each list or contact is pre-selected or selected, he can choose an optional silent profile mode of the quick dial module 102.

Exemplary Quick Dial Module

FIG. 3 is an overview of the exemplary quick dial module 102 shown in FIG. 1. The quick dial module 102 may be hardware, software, or both.

A data structure creation (and/or download) section 300 and a data structure use section 302 are communicatively coupled with a memory/database interface 304, which in turn is coupled to the memory/database 104 containing one or more quick dial data structures 306 and contact records 308. The memory/database 104 has external access, such as access to the remote computing device 105, to upload and download data, for example, when a quick dial data structure is created on a desktop computer and transferred to a mobile communications device, such as the exemplary communications device 100. A database in the remote computing device 105 can be downloaded into the memory/database 104 and converted into a quick dial data structure, or the quick dial data structure itself can be created by the remote computing device 105 and downloaded into the memory/database 104.

A list organizer 310 accesses contact records 308 in the memory/database 104 via the memory/database interface 304. The list organizer 310 creates lists of contacts with help of other communicatively coupled modules. A name (or listing) generator 312, for example, creates or accepts via user input a unifying name or characteristic for each list, i.e., chooses a common name or characteristic that all contact records 308 in a particular list will have.

Nicolas, the user, may choose list names (listings) such as “family,” “work,” “dial-up connections,” “restaurants,” “most recently used numbers,” etc. There is no limit to the number of listings that a user may choose because, in one implementation, any given list may be a list of other lists. Many portable keypads, have approximately fifteen keys including ten alphanumeric keys, however, so ten is an approximate number of listings if the quick dial module 102 assigns one list for every alphanumeric key on a fifteen key keypad 112, leaving five keys for user interface management, e.g.: “cancel current calling process,” “display selection within the menu of lists,” “display contact within a list,” movement between lists 212, etc . . . . Alternatively, an exemplary name generator 312 may allow only a preprogrammed set of listings. Although this reduces user choice, it may simplify programming of the quick dial module 102.

A preferred record filter 314 narrows a large database of contact records to a smaller set that can be more adeptly manipulated. The preferred record filter 314 screens contact records 308 from being considered by the list organizer 310. For example, all contact records 308 that have not been accessed in two months can be screened. The preferred record filter 310 does not necessarily eliminate contact records 308 from the main memory/database 104, but merely prevents certain contact records from currently being considered for use in the quick dial data structure 306. Many other criteria may be used by the preferred record filter 314 to screen contact records 308. In one exemplary system, the preferred record filter 314 is substantially a user input module, through which the user manually selects each preferred record.

A record sorter 316 may be used by the list organizer 310 or by a display modality to place contact records 308 in an order, for example in alphanumeric order according to contact info, such as contact name, city, area code, etc. Other sort options can include sorting records in order of most frequently used contact records, in order of most recently used contact records, in numerical order of keypad key assigned etc. A sort method may also be used as the theme of a list, e.g., the “most recently used list.”

A key assigner 318 may, in some implementations, associate a keypad key with a list or contact record either automatically or via user input. Some implementations of the quick dial module 102 may include a set of preprogrammed lists with preprogrammed names. In other implementations, even if automatic key assignment is used, a default setting (e.g., the lowest numbered key is assigned to the first list or the first contact in an alphabetical order) can be selected by the user. It should be noted that if a default automatic key assignment scheme is used the keys are not necessarily reassigned every time a sort is executed in a list. Infrequent key reassignment allows the user to remember which keys are assigned to particular preferred contacts, regardless of how the contacts are sorted within a list, enhancing the usefulness of quick dial technique.

An attribute assigner 320 associates the attributes discussed above, e.g., text font, foreground color, background color, sound, ring tone, graphic (icon, photo, image, picture) and/or sorting method, with each list and/or listing. The assigned attributes may be stored in each contact record in each list, in an index, or in a profile record for each list. As discussed above, additional unique attributes may be assigned to individual contacts within a list.

Interfaces for coupling with a keypad 112, video display 110, speaker 114, and other input and display devices may include a keypad interface 322, a sound interface 324, and a video display interface 326 coupled with a user interface controller 108 as illustrated. A list selector 330 and a record selector 332 are coupled with the user interface controller 108 to control the keypad 112 in relating lists and contact records 308 to keypad keys and the keypad interface states.

A keypad interface state is the particular way the keypad 112 behaves depending on logical control by the list selector 330 and the record selector 332. When the quick dial module 102 is creating or modifying the quick dial data structure 306, the list selector 330 and the record selector 332 may enable a keypad interface state in which user input is received from the keypad 112 to add, delete, or modify a contact record in a list.

When the keypad 112 is in a menu of lists 200 keypad interface state then the keys of the keypad 112 are enabled by the list selector 330 to pre-select and/or to select one of the listings on the menu of lists 200. After one of the listings on the menu of lists 200 is selected, then the record selector 332 enables a second level keypad interface state in which the keys of the keypad 112 are enabled to select a contact on the selected list.

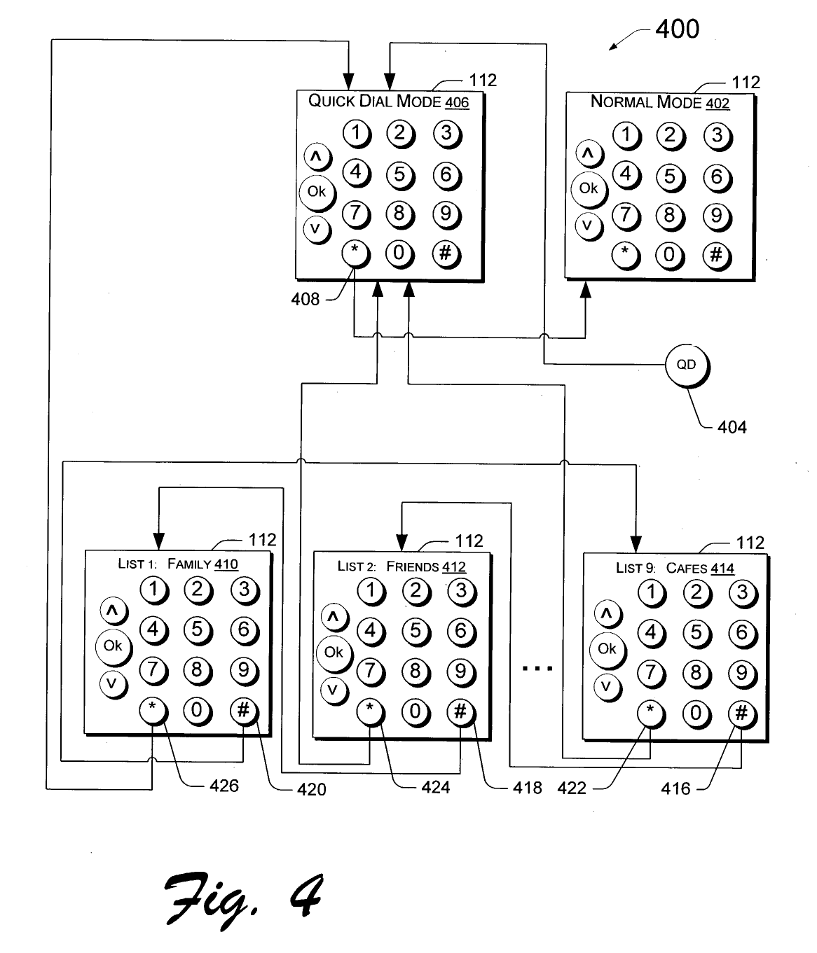

FIG. 4 shows exemplary transitions 400 between keypad interface states via assigned movement keys of the keypad 112. In one exemplary implementation of Nicolas's cell phone, his phone functions conventionally—with the keypad behaving in a normal keypad interface state (“normal mode” 402) in which each key enters one alphanumeric digit—until a quick dial activator 404 is actuated which changes the keypad 112 to a quick dial keypad interface state (“quick dial mode 406”). An assigned key, such as the “*” key 408 may act as a toggle back from quick dial mode 406 to normal mode 402.

The root quick dial mode 406 keypad interface state is used to present the menu of lists 200 to the user. When one of the lists 202 is selected from the menu of lists 200 in quick dial mode 406, a second level keypad interface state is enabled that is used to present the selected list to the user. Examples include a family list interface state 410 corresponding to the family list 212, a friends list interface state 412 corresponding to the friends list 214, and a cafés list interface state 414 corresponding to the cafés list 218.

In one exemplary implementation, a key or keys reserved for rotating between lists, that is, between the keypad interface states of the family list 212, the friends list 214, and the cafés list 218 can change a keypad interface state to another keypad interface state. Additionally, another key can be employed to return from any second level keypad interface state back to the root quick dial mode 406 keypad interface state. In the illustrated exemplary transitions 400, actuating the “#” key 416 in the cafés interface state 414 changes the keypad 112 to the interface state of the previous list in the menu of lists 200, in this case, the keypad interface state of the work list (not shown in FIG. 4). Actuating the “#” key in the work list changes the state of the keypad to the friends interface state 412, and pressing the “#” key 418 in the friends interface state 412 changes the state of the keypad 112 to the family interface state 410. If the “#” key 420 is pressed in the family interface state 410 the keypad interface state changes to the interface state of the last list in the menu of lists 200, in this case, the cafés interface state 414.

In the illustrated exemplary transitions 400, the “*” key 422, 424, 426 is set up to change the keypad interface state back to the root quick dial mode 406 interface state regardless of which list is the current keypad interface state. The assignment of the “#” key 416, 418, 420 and the “*” key 422, 424, 426 in the illustrated second level keypad interface states is just one example of how keys can be assigned for movement between keypad states in an exemplary system. Many other movement key schemes are contemplated in the subject matter.

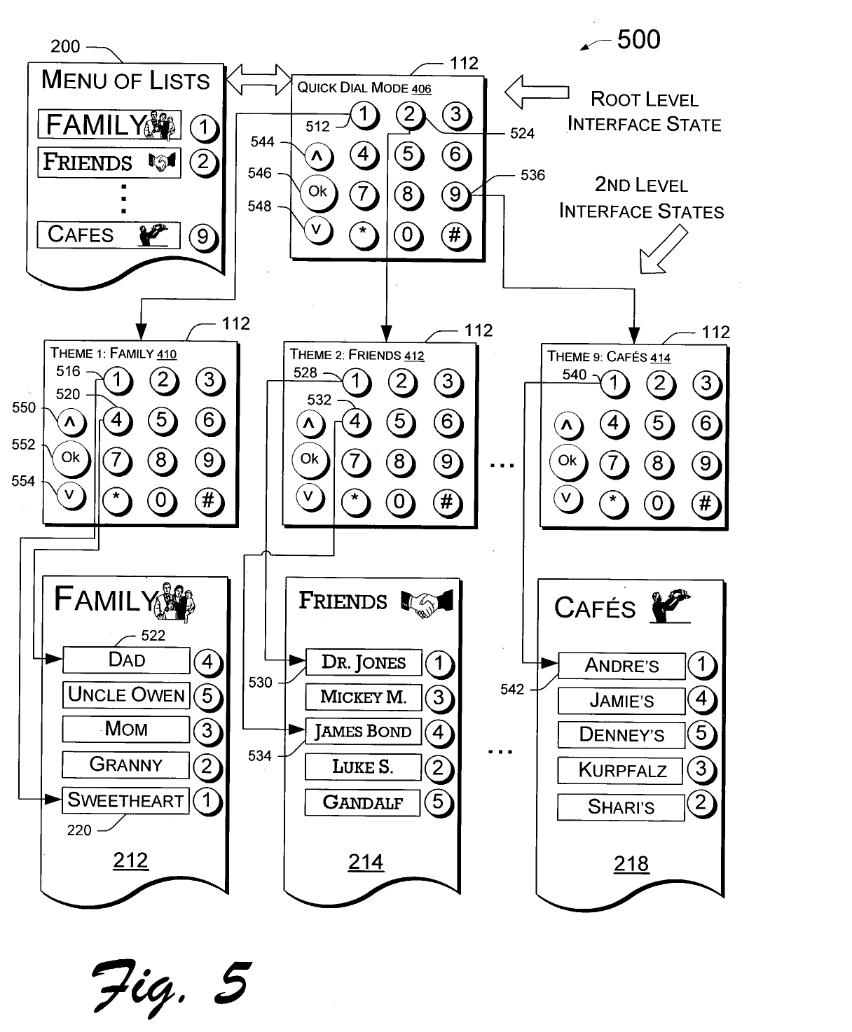

FIG. 5 further illustrates exemplary relations 500 between the root quick dial mode 406 and keypad interface states 410, 412, 414 corresponding to lists 212, 214, 218.

If the “1” key 512 is actuated in the quick dial mode 406 then the family list interface state 410 corresponding to the family list 212 is selected. A subsequent press of the “1” key 516 in the family list interface state 410 selects and/or dials the Sweetheart contact 220, whereas if the “4” key 520 is actuated instead of the “1” key 516, then the Dad contact 522 is selected and/or dialed. As discussed above, the displayed contacts in the family list 212 may have, for example, common color, background color, text font, graphic (icon, photo, image, bitmap, picture etc.), sound, ring tone and/or sort order attributes that are unique to the list.

If the “2” key 524 is actuated in the quick dial mode 406 interface state then the friends list interface state 412 corresponding to the friends list 214 is selected. A subsequent press of the “1” key 528 in the friends list interface state 412 selects and/or dials the Doctor Jones contact 530, whereas if the “4” key 532 is actuated instead of the “1” key 528, then the James Bond contact 534 is selected and/or dialed. As discussed above regarding the family list 212, the displayed contacts in the friends list 214 may have common attributes that are unique to the list.

If the “9” key 536 is actuated in the root keypad state 406 then the cafés list interface state 414 corresponding to the cafés list 218 is selected. A subsequent press of the “1” key 540 in the cafés keypad interface state 414 selects and/or dials the Andre's contact 542. Like the contacts in the other lists, the displayed contacts in the cafés list 218 may have common attributes that are unique to the list.

Instead of using an alphanumeric keypad key, the user can use the “Previous Key” (“▴”) 544 and the “Next Key” (“▾”) 548 to browse through (e.g., pre-select) the lists displayed in the menu of lists 200 and a validation key, such as the “OK Key” 546, to validate (i.e., enter and/or select) a pre-selected list. For example, upon activating the quick dial mode 406, the “family” list 212 is displayed, and in this example, automatically pre-selected in the menu of lists 200. If the user wants to access this list he presses the “OK Key” 546. If the user wants to access the friends list 214 instead of the family list 212, he pre-selects the friends list 214 by pressing the Next Key “▾” key 548 once and then validates the pre-selection by pressing the “OK Key” 546. If the user wants to access the café list 218 instead of the family list 212, he may pre-select the café list 218 by pressing the Previous Key “▴” 544 once or by pressing the Next Key “▾” key 548 eight times in a “rotating” menu of (nine) lists 200 in which the family list 212 is at the top of the menu and the café list 218 is at the bottom of the menu.

Within the menu of lists 200, the user can use the Next Key “▾” 548, Previous Key “▴” 544, and “OK Key” 546 to pre-select and select the contact he wants to call when the quick dial module 112 is displaying a particular list on the video display 110. For example, if the family interface state 410 of the keypad 112 is active, the Next Key “▾” is key 554, the Previous Key “▴” is key 550 and the “OK Key” is key 552. In one implementation, when the family list 212 is selected from the menu of lists 200, the first contact in the arranged order of the list is automatically pre-selected as the “Dad” contact 522. If the user wants to access this contact he presses the “OK Key” 552. If the user wants to access the “Mom” contact 224 instead of the “Dad” contact 522, he pre-selects “Mom” by pressing the Next Key “▾” 554 twice and validates the pre-selection by pressing the “OK Key” 552.

The keyboard interface states shown in FIG. 5 are included as part of one exemplary implementation for practicing the subject matter. On dialers such as a computer keyboard with a relatively large set of alphanumeric keys, the keys assigned to the lists and/or listings and the keys assigned to the contacts in the lists may be separate. On dialers with a relatively small number of keys, however, the same keypad key may be assigned to a list, to a contact in the list, and to multiple contacts in other lists. Once the keyboard or keypad is in quick dial mode 406, a key assigned to both a list and a contact in the list typically invokes the list when actuated a first time. Once the list is invoked then actuating the key a second time invokes the contact in the list.

Quick Dialing Methods

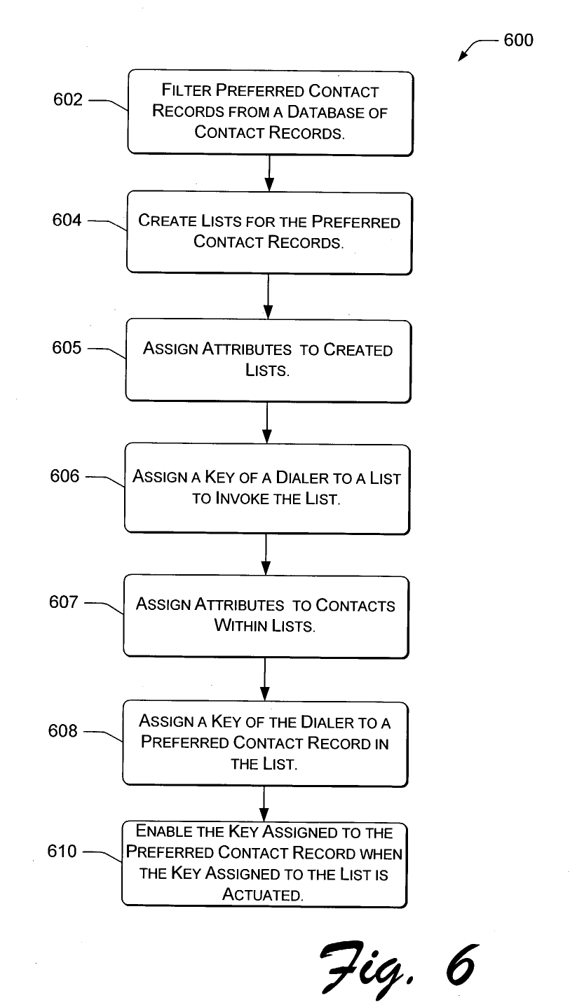

FIG. 6 shows an exemplary method 600 of creating a database structure related to the keys of a dialer. This method 600 is described as being executed by the exemplary quick dial module 102 shown in FIGS. 1 and 3, and the following description refers to the modules in those figures accordingly.

In the flow diagram, the operations are summarized in individual blocks. The operations may be performed in hardware and/or as machine-readable instructions (software or firmware) that can be executed by a processor.

At block 602, the preferred record filter 314 filters preferred contact records from a memory/database 104 of contact records 308. The term “preferred” is applied to records on one side of an arbitrary threshold. When the threshold is applied, records that are not preferred are filtered from a potentially large database of contact records 308, such as phone names and numbers. The filtering leaves a fraction of the database that can be manipulated more easily with the limited number of keys on many dialers or on selected keys of a keyboard.

At block 604, lists are created containing the preferred contact records. As discussed above, in one variation, empty lists are created before the filtering of the contact records in block 602, but in another variation lists are constructed after filtering a group of preferred contact records from a larger group of unfiltered contact records.

As discussed above in relation to FIG. 3, the name (listing) generator 312 for naming lists (and in some implementations, for naming contacts) may be dependent on user input to generate names for lists or may be preprogrammed with a limited number of pre-named lists. The name generator may also function independently by data mining existing contact records 308 to automatically develop list names based on characteristics of the contact records 308.

At block 605, attributes (as discussed in relation to FIG. 2) may be assigned to each list. The attribute assigner 320 can automatically or semi-automatically generate the attributes, for example, according to a filter that has been used to extract the contact records 308 from the memory/database 104 and/or according to pre-defined or pre-existing values. The user can also define or partially define the attributes.

At block 606, a key of a dialer is assigned to each list so that a list can be invoked by pressing a single key. The key assigner 318 in FIG. 3 may assign keys to lists by relying on user selection, may be preprogrammed to assign certain keys to predetermined listings, or may assign keys automatically, for example, by swapping the key assigned to a more frequently used list with the key assigned to a less frequently used list that has a more convenient keypad key, such as the “1” key. Typically keys are assigned to lists by the user and the key assignments of the lists remain static until a list is added or deleted, or the user selects otherwise.

In the case of contact records instead of lists, the key assigner 318 in FIG. 3 may assign keys to preferred contact records by relying on user selection, or may assign keys automatically, for example by assigning the next available key with the lowest key number to a new preferred contact record in a list. The user can have several options for having keys assigned automatically to contacts. For example, the user may periodically choose to globally reassign all key numbers for contacts in all lists according to a sorting criterion, such as alphabetical order. Or the automatic reassignment may be narrowed to one list at a time. Many variations for assigning keys to individual preferred contact records are contemplated within the subject matter. For example, within a “most recently used contact” list, the key assigner 318 might always assign the “1” key to the most recent incoming or outgoing call, the “2” key to the second most recent call, etc.

At block 607, attributes (as discussed in FIG. 2) may be assigned to each preferred contact. The attribute assigner 320 may automatically or semi-automatically generate the attributes, using the attributes of list the contact belongs to and/or the attributes of the contact record 308 as extracted from the memory/database 104 and/or according to pre-defined or pre-existing values. The user can also define or partially define the attributes.

At block 608, a key of the dialer is assigned to each preferred contact record in a list. The key assigned to a preferred contact record may be the same key that was assigned to the list containing the preferred contact record.

At block 610, the quick dial data structure 306 is created so that the key assigned to the preferred contact record is enabled to access the record when the key assigned to the list containing the preferred contact record is actuated. Thus, the preferred contact records in a list can only be invoked when the list is selected.

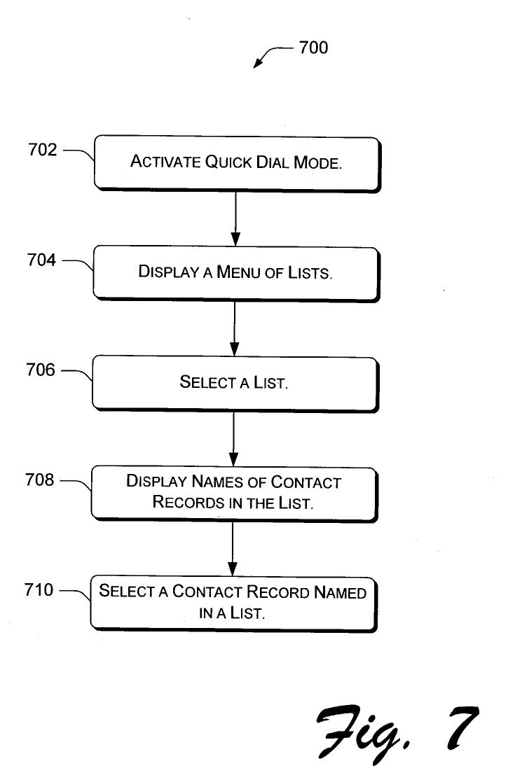

FIG. 7 shows an exemplary method 700 of using the quick dial database structure 306. This method 700 is described as being executed by the exemplary quick dial module 102 shown in FIGS. 1 and 3, and the following description refers to the modules in those figures accordingly.

In the flow diagram, the operations are summarized in individual blocks. The operations may be performed in hardware and/or as machine-readable instructions (software or firmware) that can be executed by a processor.

At block 702, a quick dial mode 406 is activated, for example, by actuating a quick dial activator 404. In the quick dial mode 406, the quick dial module 102 allows interface devices, such as the video display 110 and the keypad 112, to display and access the quick dial data structure 306.

At block 704, a menu of lists 200 is displayed on the video display 110. Attributes assigned to each listing in the menu of lists 200 may also be displayed, as well as any key(s) assigned to each listing.

At block 706, a list is selected. Attributes assigned to the selected list may confirm the selection of the list. For example, on actuating a cell phone key to select a list, the cell phone may play a sound specific to the list.

At block 708, once a list is selected, contacts in the list are displayed by the video display 110. Attributes assigned to each of the contacts in the list may also be displayed, or if no unique attributes are assigned specifically to the individual contacts, then the attributes of the list to which the contact records belong may be displayed instead.

At block 710, a contact is selected. If the contact is selected by actuating an assigned key, the assigned key is not enabled to select and/or dial the contact until the key assigned to the list containing the contact has been actuated. In one variation, once the key assigned to a list is actuated, a contact in the list is automatically designated and highlighted on the display of contacts. For example, the first contact in the list may be automatically designated once the list is selected.

Displaying Attributes Assigned to Lists and Contacts

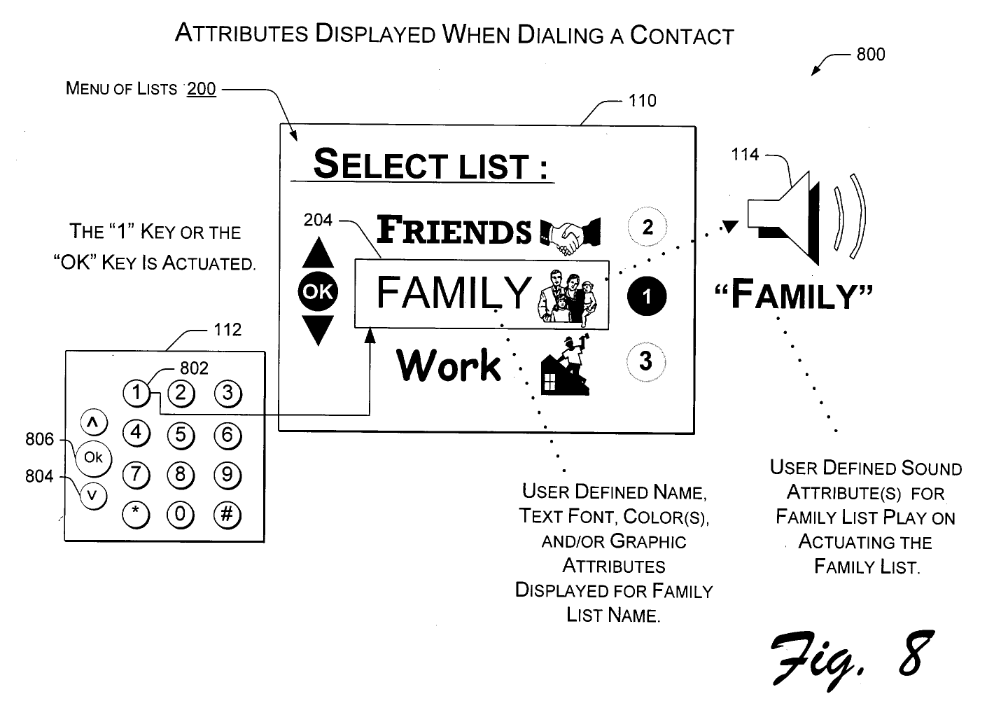

FIG. 8 shows an exemplary display 800 of video and audio attributes that can optionally appear or be played when actuating a key to select a list or to select a contact on the list.

When a user, such as Nicolas, wants to call a family member, he actuates a key 802 on the keypad 112 of his mobile phone that corresponds to the family listing 204 displayed on the video display 10. As he actuates the “1” key 802, he hears the “family” sound attribute play through the speaker 114. The video display 110 also displays the family text font, the family colors as text foreground and/or background, and may display the family graphic, such as a family icon, photo, bitmap, picture, image, etc.

In one variation, Nicolas can pre-select the family listing 204 by pressing the Next Key 804 once, and can take notice that this list has been pre-selected by viewing or hearing attributes that are associated with this list (the quick dial module 102 can also highlight the pre-selected list on the video display 110). Then Nicolas can validate his pre-selection by pressing the “OK Key” 806.

The menu of lists 200 and a particular list, such as the family list 212, can be displayed by the quick dial module 102 on video display 110 in several ways. One display modality can emphasize text names of the lists or the contacts in the lists. Another display modality can emphasize the graphic, photo, picture, image, or icon attribute associated with the lists or with the contacts in the lists. In the latter case, the user can identify a list or a contact just by recognizing the associated graphic. Some communications devices, such as the exemplary communications device 100, contain a camera to produce a photo or image etc. suitable for the graphic attribute described above.

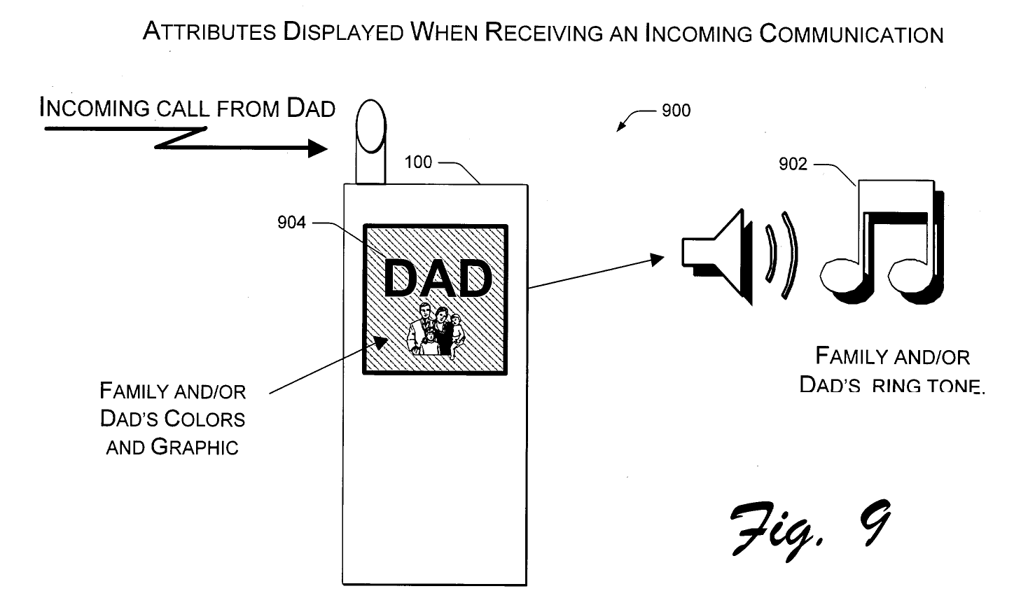

FIG. 9 shows an exemplary display 900 of attributes assigned to a list and/or an individual contact when an incoming communication is received from the contact by the exemplary communications device 100.

If the caller is a contact recognized by the exemplary quick dial module 102, then the attributes of the list 212 containing the contact may be displayed. For example, if the incoming caller is the Dad contact 522, the family ring tone attribute 902 will play and the family color 904 may appear as background or as a foreground text color on the video display 110. If specific attributes have been assigned to the Dad contact 522, then Dad's specific attributes may be displayed after or in place of displaying the family attributes 902, 904.

If the incoming caller is unidentified, then a default color and ring tone can be displayed.

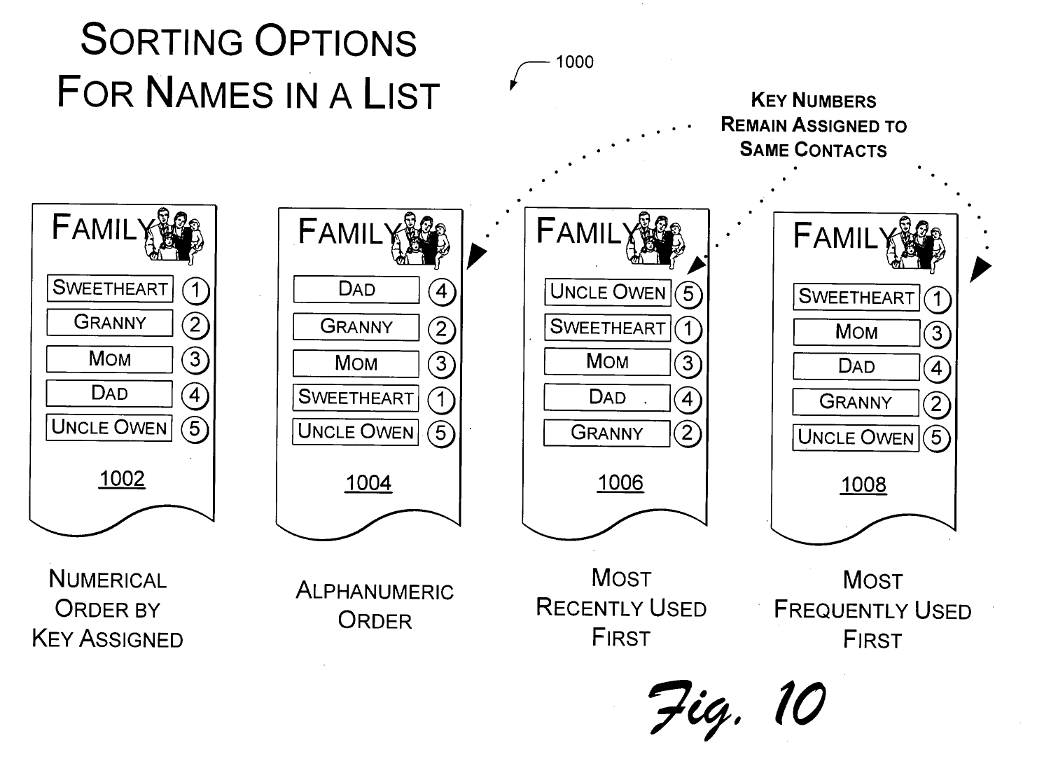

FIG. 10 shows exemplary methods of sorting lists 1000 that may be used singly or in combination in the exemplary communications device 100. One sort method, such as a sort in numerical order 1002 by assigned key number, may be used as a default to facilitate user learning of keypad keys assigned to lists and contacts.

An alphabetic or alphanumeric sort order 1004 may also be used as a default. The alphanumeric sort order 1004 option is useful in a list having unfamiliar contacts, recently input contacts, and/or contacts with frequently reassigned keys. A user can look at the video display 110 and find a desired contact in the alphabetic listing if the key number assigned to the desired contact cannot easily be remembered. The alphanumeric sort 1004 can also sort on information in a contact record besides a name, for example, the sort could be performed to arrange contacts alphanumerically by city, area code, zip code, flag, comment, etc.

A “most recently used” sort order 1006 may be useful with or without reassigning key numbers to the contacts as the list changes. In other words, in one exemplary implementation, the most recently received contact is always assigned the “1” key for ease of returning calls. In other exemplary implementations, the contacts in the list can retain previously assigned keys, to facilitate user remembrance of associations between keys and contacts. For example, in this latter type of list, Granny is always contacted by pressing the “2” key whenever the “family” list is invoked no matter which of the various sort orders 1002, 1004, 1006, 1008 is used.

A “most frequently used” sort order 1008 may be useful in one or more lists for keeping the most frequently used contacts available via only a few key actuations. Thus, the most frequently used list can be shifted to the “1” key and within the most frequently used list the most frequently used contacts can also be shifted to the “1,” “2,” “3,” . . . keys. Thus, the most frequently used contacts can be accessed by actuating only a very small set of easily remembered keys.

The record sorter 316 can also run a “most frequently used” sort of contact records in the background for list maintenance. In one exemplary implementation, if the preferred record filter 314 uses a “most frequently used” threshold for determining preferred and non-preferred records, the record sorter 316 can use the same filtering threshold in the background, grooming the lists by expiring contacts that have not been used in a long time, or that no longer exist.

Conclusion

It should be noted that the subject matter described above can be implemented in hardware, in software, or in both hardware and software. In certain implementations, the exemplary system and related methods may be described in the general context of computer-executable instructions, such as program modules, being executed by a computer. Generally, program modules include routines, programs, objects, components, data structures, etc. that perform particular tasks or implement particular abstract data types. The subject matter can also be practiced in distributed communications environments where tasks are performed over wireless communication by remote processing devices that are linked through a communications network. In a wireless network, program modules may be located in both local and remote communications device storage media including memory storage devices.

The foregoing discussion describes exemplary systems and methods for quick dialing a communications device and recognizing contacts. Although the invention has been described in language specific to structural features and/or methodological acts, it is to be understood that the subject matter defined in the appended claims is not necessarily limited to the specific features or acts described. Rather, the specific features and acts are disclosed as exemplary forms of implementing the claimed invention.

1. A method of relating a database structure to keys of a keypad, comprising:
placing identifiers of records in the database structure into lists;
assigning a key of the keypad to each list; and
assigning a key of the keypad to each record within each list, wherein a first actuation of the key of the keypad assigned to a given list selects the given list and a subsequent actuation of a key of the keypad selects a record within the given list.

2. The method as recited in claim 1, further comprising filtering the records in the database structure to reduce a number of the identifiers of records to be placed into the lists.

3. The method as recited in claim 1, further comprising establishing a menu keypad state in which the keys of the keypad access the lists.

4. The method as recited in claim 3, further comprising establishing a list keypad state in which a key assigned to a record in a given list enables access to the record after the given list has been accessed from the menu keypad state.

5. The method as recited in claim 4, further comprising assigning at least one key of the keypad to traverse from a first list to a second list.

6. The method as recited in claim 4, further comprising assigning at least one key of the keypad to traverse between keypad states.

7. The method as recited in claim 1, further comprising assigning an attribute to a list, wherein the attribute is one of a text font, a text color, a background color, a graphic, an icon, a photo, a bitmap, a picture, a sound, a ring tone, and a method of sorting the identifiers of records in the list.

8. The method as recited in claim 1, further comprising assigning the key to the list according to an order of the list relative to other lists, wherein the order is obtained by sorting the list and the other lists according to one of an alphanumeric order, an order of most recent use, an order of most frequent use, and a key order.

9. The method as recited in claim 1, further comprising assigning the key to the record according to an order of the record among other records, wherein the order is obtained by sorting the record and the other records according to one of an alphanumeric order, an order of most recent use, an order of most frequent use, and a key order.

10. The method as recited in claim 1, wherein each key of the keypad is a hard key actuated by depressing the hard key.

11. The method as recited in claim 1, wherein each key of the keypad is a soft key actuated by one of tapping an image and dragging an image.

12. A method of accessing a database structure using the keys of a dialer, wherein contacts stored in the database structure are placed into lists and a contact can be accessed after the list containing the contact has been accessed, comprising:
selecting a list by actuating a key of the dialer; and
dialing a contact within the list by actuating a key of the dialer.

13. The method as recited in claim 12, wherein selecting the list further comprises moving through a menu of lists using a key of the dialer to pre-select a list and selecting the list by actuating a key of the dialer.

14. The method as recited in claim 13, wherein selecting the contact further comprises moving through contacts in the list using a key of the dialer to pre-select a contact and selecting the contact by actuating a key of the dialer.

15. The method as recited in claim 12, further comprising assigning an attribute to the list, wherein the attribute is one of a text font, a text color, a background color, a graphic, an icon, a photo, a bitmap, a picture, a sound, ring tone, and a method of sorting the contacts in the list.

16. The method as recited in claim 15, further comprising playing the sound attribute assigned to the list when the list is one of pre-selected and/or selected.

17. The method as recited in claim 16, wherein the sound attribute is a recording of a name of the list.

18. The method as recited in claim 16, wherein the sound attribute is a name of the list recited by a text to speech engine.

19. The method as recited in claim 15, further comprising displaying one of the text font, the text color, the background color, the icon, the photo, the bitmap, and the picture assigned when the list is one of pre-selected and/or selected.

20. The method as recited in claim 15, further comprising:
receiving an incoming communication from a contact in the list; and
accessing a contact record of the contact to determine a list containing the contact record and to determine attributes associated with the list.

21. The method as recited in claim 15, further comprising playing the ring tone attribute assigned to the list when an incoming communication from a contact in the list is received.

22. The method as recited in claim 15, further comprising displaying one of the text font, the text color, the background color, the icon, the photo, the bitmap, and the picture assigned to the list when an incoming communication from a contact in the list is received.

23. The method as recited in claim 12, further comprising assigning an attribute to the contact, wherein the attribute is one of a text font, a text color, a background color, a graphic, an icon, a photo, a bitmap, a picture, a sound, and a ring tone.

24. The method as recited in claim 23, further comprising playing the sound attribute assigned to the contact when the contact is one of pre-selected and/or selected.

25. The method as recited in claim 24, wherein the sound attribute is a recording of a name of the contact.

26. The method as recited in claim 24, wherein the sound attribute is a name of the contact recited by a text to speech engine.

27. The method as recited in claim 22, further comprising displaying one of the text font, the text color, the background color, the graphic, the icon, the photo, the bitmap, and the picture assigned to the contact when the contact is one of pre-selected and/or selected.

28. The method as recited in claim 22, further comprising:
receiving an incoming communication from a contact; and
accessing a contact record of the contact to determine the identity of the contact and to determine attributes associated with the contact.

29. The method as recited in claim 28, further comprising playing the ring tone attribute assigned to the contact when an incoming communication from the contact record is received.

30. The method as recited in claim 28, further comprising displaying one of the text font, the text color, the background color, the graphic, the icon, the photo, the bitmap, and the picture assigned to the contact record when an incoming communication from the contact is received.

31. The method as recited in claim 12, wherein each key of the dialer is a hard key actuated by depressing the hard key.

32. The method as recited in claim 12, wherein each key of the dialer is a soft key actuated by one of tapping an image and dragging an image.

33. A method of using a communications device, comprising:
performing a first key actuation on the keypad of the communications device to select a list from a menu of lists, wherein the list comprises a set of contact records; and
performing a second key actuation on the keypad of the communications device to select a contact record in the list, wherein the contact record cannot be selected until the list containing the contact record is selected.

34. The method as recited in claim 33 further comprising performing, if necessary, a third key actuation on the keypad of the communications device to select a phone number from multiple phone numbers associated with the selected contact record, wherein the phone number cannot be selected until the contact record containing the multiple phone numbers is selected

35. The method as recited in claim 33, further comprising automatically dialing a phone number stored in the contact record after the contact record is selected.

36. The method as recited in claim 33, further comprising actuating a key of the keypad to change from a normal mode of keypad operation, wherein the keys of the keypad represent alphanumeric digits to a quick dial mode of keypad operation, wherein the keys of the keypad access a menu of lists and contact records in each list.

37. The method as recited in claim 33 wherein each key of the keypad is a hard key actuated by depressing the hard key.

38. The method as recited in claim 33, wherein each key of the keypad is a soft key actuated by one of tapping an image and dragging an image.

39. A communications device, comprising:
a keypad having keys;
a database of lists addressable by the keys, wherein each list comprises a set of contact records; and
a quick dial module to allow a user to access a list by actuating a key of the keypad and to access a contact record in the list by actuating a key of the keypad, wherein a key cannot access the contact record until a key accesses the list containing the contact record.

40. The communications device as recited in claim 39, further comprising an assigner to link an attribute with a list, wherein the attribute is one of a text font, a text color, a background color, a graphic, an icon, a photo, a bitmap, a picture, a sound, a ring tone, and a method of sorting the set of contact records in the list.

41. The communications device as recited in claim 40, further comprising a camera to create the graphic, icon, photo, bitmap, and/or picture.

42. The communications device as recited in claim 40, further comprising a display device to display the attribute when a communication is received from a contact in the list.

43. The communications device as recited in claim 39, further comprising an assigner to link an attribute with a contact record, wherein the attribute is one of a text font, a text color, a background color, an icon, a photo, a bitmap, a picture, a sound, and a ring tone.

44. The communications device as recited in claim 43, further comprising a display device to display the attribute when a key is actuated to one of pre-select the contact record and/or select the contact record.

45. The communications device as recited in claim 43, further comprising a display device to display the attribute when a communication is received from a contact in the contact record.

46. The communications device as recited in claim 39, further comprising a filter to reduce a number of the contact records to place in each list.

47. The communications device as recited in claim 39, further comprising a record sorter to sort each list for display.

48. The communications device as recited in claim 47, wherein each list is sorted according to an assigned sorting method attribute.

49. The communications device as recited in claim 48, wherein the method of sorting is one of sorting according to alphanumeric order of a name associated with the contact record, sorting according to most recent use of contact records in the list, sorting according to most frequent use of contact records in the list, and sorting according to numerical order of keys assigned to contact records in the list.

50. The communications device as recited in claim 49, further comprising a record sorter to automatically perform background sorting of contact records to remove least frequently used contact records from a list.

51. The communications device as recited in claim 49, further comprising a record sorter to automatically perform background sorting of contact records to remove contact records that no longer exist in a database of the communications device.

52. The communications device as recited in claim 49, wherein each key of the keypad is a hard key actuated by depressing the hard key.

53. The communications device as recited in claim 49, wherein each key of the keypad is a soft key actuated by one of tapping an image and dragging an image.

54. A data structure for a directory database accessible by a phone, comprising:
a root directory containing multiple lists, wherein each list is assigned a respective key on a keypad of the phone and each list is accessible by actuating its assigned key; and
contact records in the multiple lists, wherein the contact records are assigned keys on the keypad and each contact record is accessible by pressing its assigned key, further wherein the contact record is accessible only after a list containing the contact record has been accessed.

55. The data structure as recited in claim 54, wherein each list has a list name.

56. The data structure as recited in claim 55, wherein the multiple lists are sorted according to one of an alphabetical order of their names, a most frequently used order, a most recently used order, and a numerical order of assigned key number.

57. The data structure as recited in claim 55, wherein contact records in one of the multiple lists are sorted according to one of an alphabetical order, a most frequently used order, a most recently used order, and a numerical order of assigned key number.

58. The data structure as recited in claim 55, wherein each list is assigned an attribute, including one of a text font, a text foreground color, a text background color, an icon, a photo, a bitmap, a picture, a sound, and a ring tone.

59. The data structure as recited in claim 55, wherein each contact record in a list is assigned an attribute, including one of a text font, a text foreground color, a text background color, an icon, a photo, a bitmap, a picture, a sound, and a ring tone.

60. A phone dialing system, comprising:
a dialer having keys;
a database of contact information organized into records having contacts and addressable by the keys;
a list organizer to place at least a name of each of at least some of the records into multiple lists;
a list selector to invoke one of the multiple lists by actuating one of the keys;and
a record selector to invoke a record in the list by actuating one of the keys, wherein the record selector cannot invoke the record until the list is invoked.

61. The phone dialing system as recited in claim 60, further comprising an attribute assigner to link an attribute to the list, wherein the attribute is one of a text font, a text foreground color, a text background color, an icon, a photo, a bitmap, a picture, a sound, and a ring tone.

62. The phone dialing system as recited in claim 61, further comprising a display to show the attribute of the list when the key assigned to the list is actuated, or when the list is pre-selected by actuating one or several times the next and/or previous key.

63. The phone dialing system as recited in claim 61, further comprising a display to show the attribute of the list when a communication is received from a contact in a record at least named in the list.

64. The phone dialing system as recited in claim 60, further comprising an attribute assigner to link an attribute to the record, wherein the attribute is one of a text font, a text foreground color, a text background color, a graphic, an icon, a bitmap, a picture, a sound, and a ring tone.

65. The phone dialing system as recited in claim 64, further comprising a display to show the attribute of the record when the record is one of pre-selected by actuating a key and/or selected by actuating a key.

66. The phone dialing system as recited in claim 64, further comprising a display to show the attribute of the record when a communication is received from a contact in the record.

67. The phone dialing system as recited in claim 60, further comprising a switch to change between a normal mode of dialer operation, wherein the keys of the dialer represent alphanumeric digits, to a quick dial mode of dialer operation, wherein the keys of the dialer access the multiple lists.

68. The phone dialing system as recited in claim 60, further comprising a sorter to arrange the lists and the preferred records in one of an alphabetical order of their names, a numerical order according to key number, an order of most frequent use, and an order of most recent use.

69. The phone dialing system as recited in claim 60, wherein each key of the dialer is a hard key actuated by depressing the hard key.

70. The phone dialing system as recited in claim 60, wherein each key of the dialer is a soft key actuated by one of tapping an image and dragging an image.

71. A mobile telephone device, comprising:
a handheld dialer wherein each key of the dialer can be actuated by a part of a hand holding the handheld dialer; and
a database of contact information accessible by the handheld dialer, wherein the contact information is grouped into categories traversable by the keys of the dialer, and wherein a first actuation of one or more keys of the dialer selects a category and a subsequent actuation of one or more keys of the dialer dials a phone number from the category.

72. The mobile telephone device as recited in claim 71, further comprising an attribute assigner to link an attribute to a category, wherein the attribute is one of a text font for a category name, a text foreground color, a text background color, an icon, a photo, a bitmap, a picture, a sound, and a ring tone.

73. The mobile telephone device as recited in claim 72, further comprising a display to show the attribute of the category when the category is one of pre-selected and selected.

74. The mobile telephone device as recited in claim 71, wherein each key of the dialer is a hard key actuated by depressing the hard key.

75. The mobile telephone device as recited in claim 71, wherein each key of the dialer is a soft key actuated by one of tapping an image and dragging an image.

76. One or more computer readable media containing instructions that are executable by a computer to perform actions comprising:
selecting preferred contact records from a database of contact records to be accessed by the dialer of a communications device;
placing names of the preferred contact records into categories;
accessing a category by actuating a key of the dialer; and
accessing a preferred contact record in a category by actuating a key of the dialer, wherein the preferred contact record cannot be accessed until a category containing the preferred contact record is accessed.

77. One or more computer readable media as recited in claim 76, the actions further comprising assigning one of a color attribute, a text font attribute, a graphic attribute, an icon attribute, a photo attribute, a bitmap attribute, an image attribute, a sound attribute, and a ring tone attribute to each category.

78. One or more computer readable media as recited in claim 77, the actions further comprising playing the sound attribute assigned to a category when the category is one of pre-selected and selected.

79. One or more computer readable media as recited in claim 77, the actions further comprising displaying one of the color attribute, the text font attribute, the icon attribute, the photo attribute, the bitmap attribute, and the image assigned to a category when the category is one of pre-selected and selected.

80. One or more computer readable media as recited in claim 77, the actions further comprising playing the ring tone attribute assigned to a category when an incoming communication is received from a contact in a preferred contact record in the category.

81. One or more computer readable media as recited in claim 77, the actions further comprising displaying one of the color attribute, the text font attribute, the icon attribute, the photo attribute, and the image attribute assigned to a category when an incoming communication is received from a contact in a preferred contact record in the category.

82. One or more computer readable media as recited in claim 77, the actions further comprising sorting preferred contact records in a first category by a different sort method than the preferred contact records in a second category, wherein the sort methods are selected from a group of sort methods consisting of sorting the preferred contact records alphabetically by name, sorting the preferred contact records numerically according to assigned key numbers, sorting the preferred contact records by frequency of use, and sorting the preferred contact records according to most recent use.
